(19) United States
(12) Patent Application Publication
(10) Pub. No.: US 2011/0060651 A1
(43) Pub. Date: Mar. 10, 2011

(54) System and Managing Customized Advertisement Using Indicator on Webpage

(76) Inventor: Moon-Sung Choi, Seoul (KR)

(21) Appl. No.: 12/666,784

(22) PCT Filed: Aug. 8, 2008
(86) PCT No.: PCT/KR08/04644

§ 371 Date: Nov. 18, 2010

(30) Foreign Application Priority Data
Aug. 10, 2007 (KR) 10-2007-0080456

(51) Int. Cl. G06Q 30/00

(52) U.S. Cl. 705/14.54; 705/14.72; 705/14.71

(57) ABSTRACT

The present invention relates to a system for managing a customized advertisement that uses an indicator, the system including: a layer that is stacked on a surface of a specific web page at a size corresponding to a web page and is output on a monitor; a layer forming module that activates the layer when the specific web page is activated and controls the size of the layer to the size of the web page; at least one indicator that is included in the layer and is associated with coordinate values corresponding to specific contents or space positions to be exposed on the surface of the specific web page; and indicator generating module that generates the indicator; an indicator establishing module that forms advertisement contents in the indicator and determines an advertisement progress by a bidding unit performing a bid for an advertiser target; and a calculation module that calculates advertisement costs according to the progress of the advertisement. In the system for managing the customized advertisement that uses the indicator in the web page according to the present invention, the layer is formed on the surface of the web page and the advertisement means referred to as the indicator is displayed on the layer, such that the advertisement can directly be implemented on the web page at low cost and still stimulate the user's curiosity, making it possible to create a new advertisement paradigm, which can stimulate the interest of advertisers and users pursuing various desires.

### TECHNICAL FIELD

The present invention relates to a system for managing a customized advertisement using an indicator on a webpage, and more particularly to a system for managing an advertisement that provides a new advertising medium which, when various information are output together within a single webpage through a monitor, is implemented by an indicator that stacks important advertisement contents from among the various information on his or her desired webpage by using separate transparent layers and display advertisement contents on the transparent layers, where the user produces the advertisement contents himself or herself or selects various advertisement contents provided by service providers and displays the advertisement contents on the webpage that is desired to be exposed that uses the indicator which selects and settles various advertisement options such as costs, periods, forms, keywords, links, or the like that the are bidded by the user or provided by the service providers; and furthermore, a plurality of users can generate a plurality of indicators recorded with the user's advertisement information in various sizes on a certain website as well as the indicators generated by other users and a plurality of webpages generated by the same indicator are evaluated according to preferences of various consumers to be used as the subject generating user indicators.

In addition, the present invention relates to a system that can implement a new advertisement market and advertisement form by selectively arranging and utilizing URLs of the webpage that are desired so as to expose the indicator produced or selected by the user and predetermined information, by providing a scheme that can diversely make a selection without being compared with the existing advertisement system and a customized advertisement for each user, since the user who has produced an indicator having a consumer's high preference can calculate advertisement periods and costs and other user may select his or her advertisement contents or webpages to be advertised.

### 2. BACKGROUND ART

The modern society has been introduced to advanced knowledge in an society, in which in this era, various information is mass produced, collected, analyzed and utilized by a producer, such that a consumer applies indispensable conditions, which creates the need for their existence. That is, the producer needs more efficient production and sales information, and the consumer needs more efficient consumption information.

In other words, the steps for providing logistics information between the producer and consumer has been created where there is one-to-one correspondence between the producer and consumer, establishing a business environment where the producer and consumer coexist with each other. For example, the producer does business with the consumer, thereby reducing the need in the distribution sector of all industrial sectors, such as e-bay or G-market. E-bay is a famous U.S. product distribution website and G-market is a famous domestic product distribution website in Korea. This type of direct business has actively progressed in the online service areas as well as the products.

As the society technologically advances, an advertisement market which connects the producer with the consumer has recently come into spotlight. In particular, in the era of information highway due to the Internet, the advertisement field has undergone innovational changes. In other words, advertising mediums such as TV, newspapers, magazines, sign boards, or the like has progressed as an indiscriminate advertisement tools for unspecified individuals, whereas the on-line advertising medium represented on the Internet, such as Google and Yahoo, optimizes advertising effects by sorting, selecting and progressing the object to be advertised, that is relatively exact compared to the existing advertising medium, such as search advertisement, sponsor advertisement, URL advertisement, or the like, which establishes and operates a system where an individual or a company can participate with ease in respect to the demand and supply of advertisement, thereby expanding the existing advertisement region and a market share, and creating new paradigms and value-added services in the advertisement market.

Currently, three companies, such as NHN, Daum, and Nate, control the on-line advertisement market through the Internet in Korea, and Google, Yahoo, and Microsoft control more than 80% of the entire U.S. market. One of the current representative of on-line advertisement methods is ‘Search and Sponsor Advertisement’ which shows an advertisement most suitable for the information inputted when a consumer searches for information, and the other is ‘Display Advertisement (Banner or Pop-up advertisement)’ which optimizes advertising effects by exposing the advertisement to a website where users frequently visit. The on-line advertisement market may be sorted largely into a search advertisement and a display advertisement, despite being slightly different between companies. The influence of the search and display advertisements have been more effective, because the advertising effects of the search and display advertisements provides more exact and effective advertising the unspecified mass advertisements of the existing media.

Further, the on-line advertisement method by the sponsored search of advertising medium is progressive and cost-effective compared to the existing media. However, this type of on-line advertisement method has problems in that together with unregulated practices such as unclear search ranking and clock fraud, sponsors do not know when and where their advertisements are exposed so they can only perform a quantitative evaluation on the number of clicks or visitors. In other words, the sponsors have difficulty in setting their desired advertising positions and are only able to determine access information through IPs, which makes it difficult to evaluate the quantitative advertising effects, such as how their advertisements are visited and through which customers.

In the case of the display advertisement, there are many difficulties for ordinary people to approach the advertisement in view of techniques and costs. For example, it is assumed that a patent attorney, who newly opens a patent office, applies a search advertisement for two words “patent” and “patent attorney”, in order to advertise the patent office. In this case, when someone inputs “patent” or “patent attorney” into a search window, the existing search advertisement shows the advertisement (site address) of the patent office within a predetermined standard and position from the upper to the lower as the search result. In this case, the display advertisement is advantageous in that it is more exact compared to the existing media advertisement and the advertising costs are also paid in proportion to the advertising effects.

As described above, however, the problem, such as measuring whether the advertiser performs the advertisement at the desired size and position or if the user inputs a click fraud or a keyword can be considered as the advertisement target is still not solved. Also, in the case of the display advertisement, the greatest potential customers of the new patent office, that is, persons that want to be serviced from Patent Attorney or persons that visit a website of the Korean Intellectual Property Office or famous Patent Offices can be considered as the advertisement targets. The most efficient method for generating advertisement for the potential customers is achieved by inserting the display advertisement in the website of the Korean Intellectual Property Office or famous Patent Offices. In actuality, however, inserting the banner advertisement in the website of the Korean Intellectual Property Office has problems of costs and fairness. Further, it is impossible to permit banners for rival patent offices.

Therefore, the search advertisement or the banner advertisement is considered to be advanced advertisement over the existing advertisement, but the selection of advertisers that wants to advertise is largely limited and the customized services given to the advertiser have predetermined limitation. Further, it is impossible for a general user to expose his/her desired advertisement at the desired position, price, period, and form. The customized advertisement uses the indicators according to the present invention and the services provided by the system of the present invention.

The current twenty-first century is the age of flood advertisement, in which advertisement method has been efficient and communication between producers and consumers become core elements for maintaining their existence. Thus, a communication path that can more accurately connect the producers to the consumers is needed. Therefore, providing a system for managing advertisement is provided as an optimal advertisement method for achieving a communication path between producer and consumers. As a result, a new paradigm exists in the advertising market which can provide customized advertisement to meet various advertisement demands required from an individual while creating an enterprise in view of a user's demand.

### DISCLOSURE OF INVENTION

### Technical Problem

The present invention proposes to solve the problems. It is an object of the present invention to efficiently maximize smooth communication and efficiency, which are the chief goals of advertisement, by generating a customized medium provided on a web page in a specific scheme, that is, an indicator using coordinate values of a web browser and URL of the corresponding web page and by providing a means that selects, reserves, settles, calculates, and feedbacks the advertisement interlocked with the indicator, such that a user or an advertiser can produce, bid, reserve, execute, confirm, and feedback the advertisement while actually confirming the optimal customized advertisement of their desired shape, price, period, targets, etc on the web page to which the advertisement is exposed to mass consumers.

It is another object of the present invention to perform a basic data analyzing function for efficiently executing an advertisement service by analyzing access information generated by a user, an advertiser, and a visitor visiting a web page so as to perform an indicator advertisement on the web page where the indicator is displayed.

It is still another object of the present invention to create convenience of a user in the production, execution, and evaluation of an advertisement by sharing and executing information with other digital media by providing a data exchange means and a format conversion means so as to connect an indicator to various media, that is, digital advertisement media, such as radio, cable, Internet, mobile communication, etc.

It is still another object of the present invention to create convenience for a user for confirming various evaluations, management, classification, advertisement effect, etc. of visitors to the web page by stacking an indicator generated by another user or advertiser on an advertisement indicator generated by a specific user or advertiser using various standards, such as period, price, shape, size, preference, etc.

It is still another object of the present invention to provide an advertisement related transaction means that is capable of performing systematic evaluation of production, sales, management, and evaluation of an advertisement by providing a means that can record the transaction of an advertisement database produced by a user so as to re-edit, process, purchase an indicator database produced and managed by a user or an advertiser such that the indicator database meets other user taste.

It is still another object of the present invention to manufacture a system that can distribute profits to a producer producing an indicator, an owner of a web page on which the indicator is displayed, an advertisement consumer viewing the advertisement services, and an advertisement service provider at a predetermined ratio so as to build a Win-Win model that maximizes the profits of all the participants, such as an advertisement producer, an consumer, and an intermediary, etc.

It is still another object of the present invention to confirm and use contents represented inside and outside an indicator anytime regardless of location by changing various contents in the indicator into various formats, including wire and wireless.

### Technical Solution

In order to achieve the above-mentioned objects, there is provided a system for managing a customized advertisement using an indicator according to the present invention on a web page that is operated to target users in which an indicator management program is installed on a client server, the system including: a layer that is stacked on a surface of a specific web page at a size corresponding to a web page and is displayed on a monitor; a layer forming module that activates the layer when the specific web page is activated and controls the size of the layer to the size of the web page; at least one indicator that is included in the layer and is associated with coordinate values corresponding to specific contents or space positions to be exposed on the surface of the specific web page; an indicator generating module that generates the indicator; an indicator establishing module that forms advertisement contents in the indicator and determines an advertisement progress by a bidding unit performing a bid for an advertiser target; and a calculation module that calculates advertisement costs according to the progress of the advertisement.

### ADVANTAGEOUS EFFECTS

As described above, in the system for managing the customized advertisement that uses the indicator on the web page according to the present invention,

1) the layer is formed on the surface of the web page and the advertisement means referred to as the indicator is displayed on the layer, such that the advertisement can directly be implemented on the web page to stimulate user's curiosity, making it possible to create a new advertisement paradigm which can stimulate the appetite of advertisers and users pursuing various desires;

2) the customized advertisement medium, that is, the indicator, which is provided on the web page in the specific method by using the coordinate values of the web browser on which the advertisement is exposed and the URL of the corresponding web page is generated and the smooth communication effect and efficiency that is a final object of the advertisement can be maximized by providing the means that selects, reserves, settles, calculates, and feedbacks the advertisement interlocked therewith;

3) the access information generated by the user or the advertiser that performs the indicator advertisement on the web page on which the indicator is displayed and the visitor that visits the web page is analyzed in order to perform a basic data analysis function for executing an efficient advertisement service; and,

4) creating convenience for a user for production, execution, and evaluation of the advertisement can be executed by sharing and executing information with other digital media by providing a data exchange means and a format conversion means so as to connect the indicator to various media, that is, the digital advertisement media, such as radio, cable, Internet, mobile communication, etc; and

5) the advertisement indicator generated by the specific user or the advertiser can be stacked on the indicator generated by other users or advertisers using various standards, such as periods, prices, shapes, sizes, preferences, etc., making it possible to provide convenience to the user which is capable of naturally leading to the competition between the indicators as well as confirming the various evaluation of the web page visitor, the management classification, the advertisement effect, etc.

### BRIEF DESCRIPTION OF DRAWINGS

FIG. 1 is a conceptual diagram showing a schematic configuration of a system for managing a customized advertisement using an indicator according to the present invention;

FIG. 2 is a conceptual diagram for assisting a basic understanding of the indicator according to the present invention;

FIG. 3 is a block diagram showing a detailed configuration of a system for displaying and managing a customized advertisement that uses the indicator according to the present invention;

FIG. 4 is a block diagram showing a relation of each component of a system for managing a customized advertisement that uses the indicator according to the present invention;

FIG. 5 is a view exemplifying a process of applying the customized advertisement that uses the indicator in the advertisement establishing page using the function of an indicator that establishes a module according to the present invention;

FIG. 6 is a view exemplifying a process of bidding the advertisement according to the present invention;

FIG. 7 is a view exemplifying a process of accepting the advertisement according to the present invention;

FIG. 8 is an exemplification view showing a process of approving the advertisement according to the present invention; and

FIG. 10 is a flow chart showing a web page moving grasp process by a web page moving grasp module according to the present invention.

### DETAILED DESCRIPTION OF MAIN ELEMENTS

10: SYSTEM
120: INDICATOR GENERATING MODULE
20: CLIENT SERVER
121: BLOCK ESTABLISHING UNIT
25: INDICATOR MANAGEMENT PROGRAM
122: COORDINATE ESTABLISHING UNIT
30: SYSTEM SERVER
124: STORING UNIT
60: DB SERVER
125: LAYER OUTPUT UNIT
70: TOOL BAR
130: INDICATOR ESTABLISHING MODULE
100: INDICATOR
131: CONTENTS ESTABLISHING UNIT
101: LAYER
134: KEYWORD ESTABLISHING UNIT
105: INDICATOR DATABASE
136: EXPOSED TIME ESTABLISHING UNIT
107: ADVERTISEMENT DATABASE
140: EXTERNAL CONNECTION UNIT MODULE
109: INTERLOCKING DATABASE
141: PROFIT DISTRIBUTING UNIT
110: LAYER FORMING MODULE
150: WEB PAGE MOVING GRASP MODULE
111: ACTIVATION UNIT
151: MOVEMENT MESSAGE GENERATING UNIT
112: LAYER SIZE AUTO-ESTABLISHING UNIT
152: MESSAGE DATABASE STORING UNIT
113: LAYER TRANSPARENCY CONTROLLING UNIT
160: ACCESS INFORMATION GRASP MODULE
115: INDICATOR POSITION CONTROLLING UNIT
170: INTERLOCKING MODULE
116: MULTI-LAYER FORMING UNIT

### BEST MODE FOR CARRYING OUT THE INVENTION

Hereinafter, embodiments of the present invention will be described with reference to the accompanying drawings. The accompanying drawings are not necessarily to scale and like reference numerals throughout the drawings denotes like components.

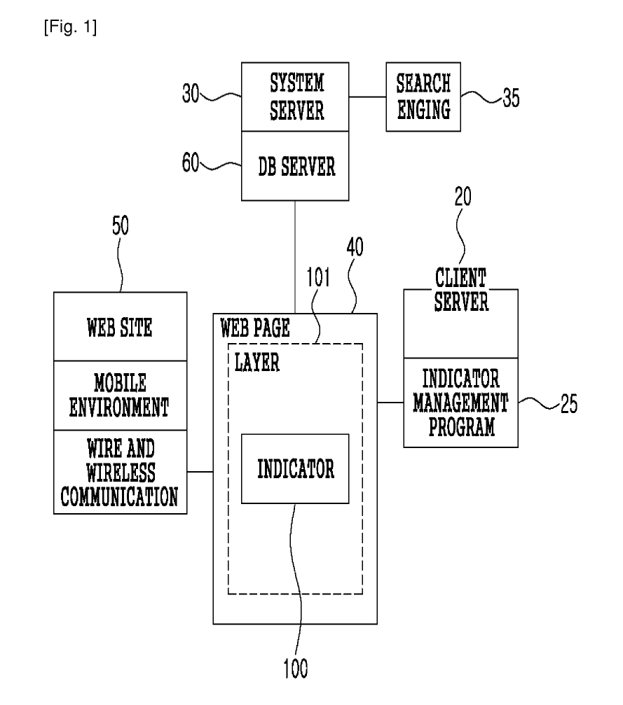

FIG. 1 is a conceptual diagram showing a schematic configuration relation of a system 10 for managing a customized advertisement using an indicator according to the present invention.

The system 10 for managing the customized advertisement that uses the indicator according to the present invention can freely attach a unique configuration, which is referred to as an indicator 100, to specific locations or specific contents in a web page by an advertisement establishing procedure and separately store the web page 40 by storing and sorting the web page 40 on which the indicator 100 is displayed as and into a web document, a file, etc., and includes a client server 20 that is the main component of generating the indicator 100 and a system server 30 that performs a function of assisting and managing the generation process, each server 20 and 30 being connected to each other in real time through a web site 50 or wire/wireless communication to share the indicator 100, thereby usefully using the specialized customized advertisement of other users.

Referring to FIG. 1, it can be appreciated that the client server 20 used by the user is installed with an indicator management program 25.

The indicator management program 25 is installed on a client toolbar to a user's computer to generate, drive, and manage the indicator 100. In other words, the indicator management program performs a basic role of providing a general interface capable of using the indicator 100 manufactured by the user.

The indicator 100 manufactured by the user is identified through the web page 40 and the users having the indicator management program 25 are interlocked with each other through a DB server 60 and the system server 30.

The DB server 60 performs a function of storing various databases created through the system according to the present invention, such as a user information database 106, an indicator database 105, an advertisement database 107, or the like and the system server 30 calls an indicator 100 to the users that are interlocked with each other and has a central management function for an advertisement executing procedure as well as providing functions to perform various applications, such as user's detailed access information using the indicator 100, user's ripple and score management according to the advertisement, cost calculation, an advertisement information transaction, etc., through the indicator according to the present invention. The functions thereof will be described in detail by describing each module below.

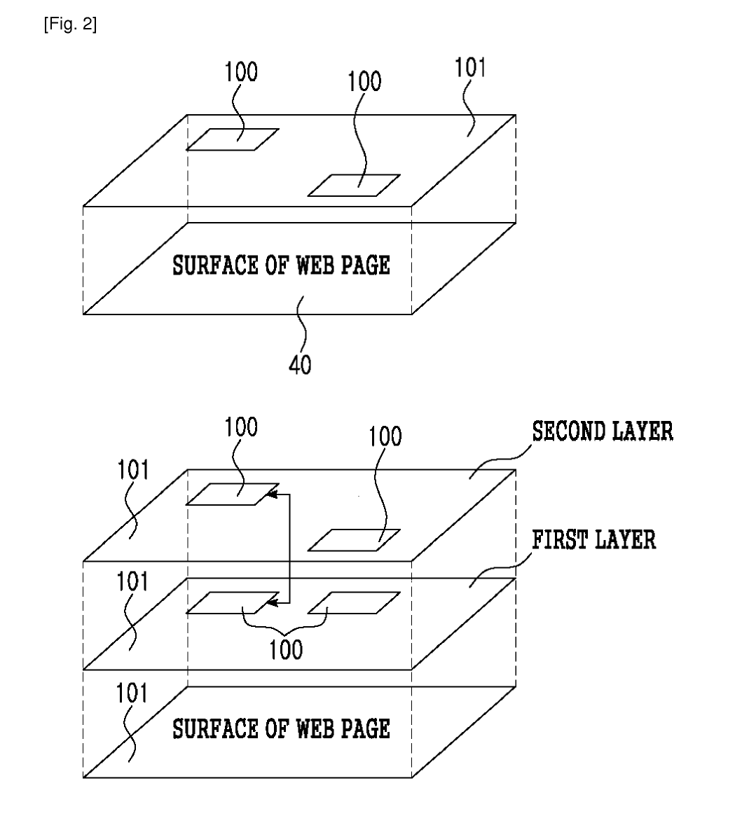

FIG. 2 is a conceptual view for assisting a basic understanding of the meaning of the indicator according to the present invention.

The indicator 100 described in the present invention is a block space having a predetermined size that is displayed in a portion corresponding to a document, a picture, a moving picture, etc., which are recorded in the web page 40. Like an online scratch paper on the web performing a function similar to a scratch paper attached to a general note or a document, for example, trade mark “Post It” available from 3M Co., the indicator 100 can be attached to anywhere by the user as desired, such that it can be used as the advertisement. In other words, the indicator 100 is used as a concept to replace a display advertisement medium of an existing pop-up advertisement having a various forms or a banner advertisement attached to a certain position that can easily be identified when the user visits the web site. Accordingly, the user having the indicator management program 25 can implement the customized advertisement anywhere on the web page by using the indicator 100.

The indicator 100 can be formed at a specific position of the web page 40. The formation method of the indicator 100 mainly uses a method of attaching the indicator on a surface of the web page 40 based on the user's preference, not physically inserting the indicator 100 into the web page 40 by the web page structure, that is, a source or a web language for constructing and executing the web page.

In other words, the indicator 100 is displayed on a separate layer 101 (preferably, transparent layer) on the surface of the web page 40. When viewing, from the user's viewpoint, the position where the layer 101 on which the indicator 100 is displayed are stacked on the web page 40, it seems that the indicator 100 is attached to the web page 40.

In order for the indicator to be accurately formed having specific content or position of the web page 100, the indicator is formed the layer 101 that grasps a coordinate value of a position where it will be displayed. Furthermore, the plurality of indicators 100 can be formed at different positions on the web page 40 or otherwise, the plurality of indicators 100 can be displayed on the plurality of stacked layers 101 at the same position.

Further, the indicator 100 can be represented in various forms and formats, for example, any one of various exposing formats which are currently known formats, such as moving picture (html insertion, embedded form, etc), flash, document, hyperlink, etc.

The operation and advertisement method that uses the indicator 100 according to the present invention can be achieved by allowing the user having the indicator management program 25 to select the desired advertisement forms based on the block space formed in a predetermined size that is referred to as the indicator 100 and then to establish and settle the customized advertisement at the desired position of the web page 40 on which the advertisement will be inserted through an indicator establishing module 130 and a calculation module 140 and by activating the web page 40 in the state where the indicator 100 recording the advertisement contents is displayed when the user having the indicator management program 25 visits the web page 40.

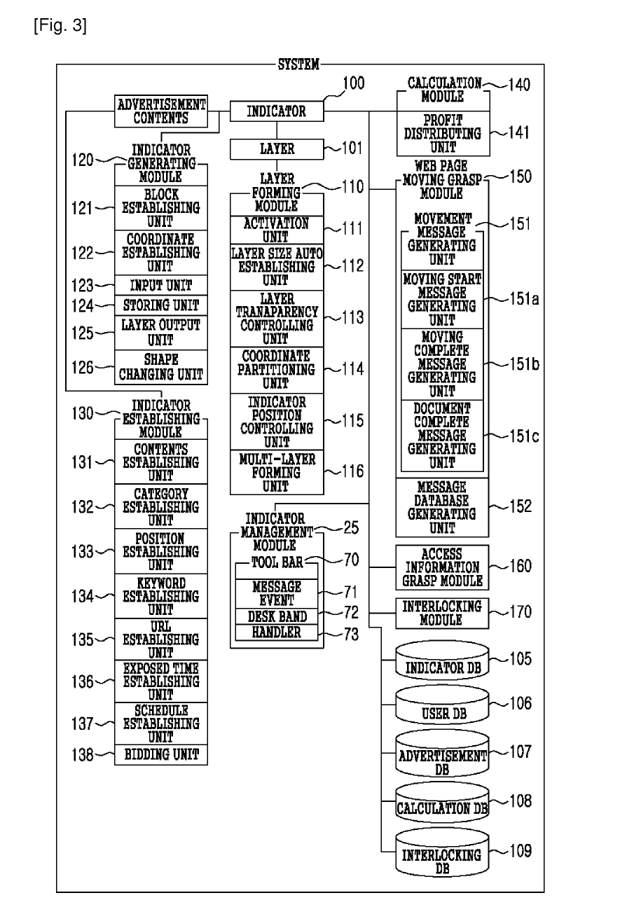

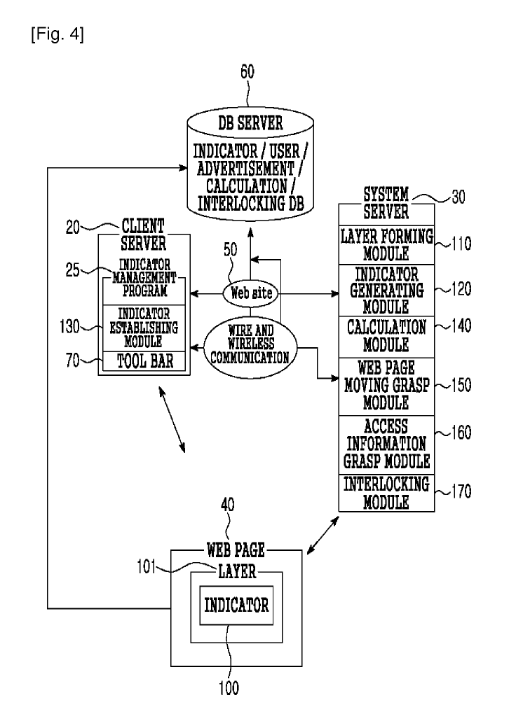

FIG. 3 is a block diagram showing a detailed configuration of a system for displaying and managing a customized advertisement that uses the indicator according to the present invention. FIG. 4 is a block diagram showing a relationship of each component of the system 10 for managing the customized advertisement that uses the indicator according to the present invention on the basis of the server.

Referring to FIG. 3, the system 10 according to the present invention includes: the indicator 100 that is generated on the layer 101 on the web page in the state where the client server 20 and the system server 30 are interlocked with each other in real time; a layer forming module 110 that forms the layer 101 required to be generated in the specific web page; an indicator database 105 that stores position information and content information on the indicator together; an indicator generating module 120 that performs a generation role of the indicator; the indicator establishing module 130 that establishes the overall advertisement contents through the indicator; the calculation module 140 that processes and calculates predetermined costs when forming the customized advertisement in the indicator 100 according to the user's preference; a web page moving grasp module 150 that grasps a web site surfing situation of the user having the indicator management program; an access information grasp module 160 that analyzes and manages various information, such as the number of clicks, visitors, an amount of advertisement, a period of advertisement, etc., which are grasped by the web page moving grasp module 150; and an interlocking module 170 that can exchange indicator information with various information devices, such as mobile phones, PDAs, MP3, PMP, TV, etc., for sharing and processing various information with the client server 20, various external servers, and the system server 30.

Also, the system according to the present invention manages various information, which is generated, modified, deleted, and stored in all the processes, through the indicator database 105. The system includes a user database 106 that stores and manages information on the user distributing the indicator management program 25 in addition to the user's basic personal information; an advertisement database 107 that records advertisement related information, such as various advertisement related contents, advertisement user information, advertisement effects, etc. for the customized advertisement that uses the indicator 100; a calculation database 108 that manages various functions and contents for settlement and calculation required to perform the customized advertisement; and an interlocking database 109 that is interlocked with the external system or the DB to be able to expand users and services, wherein the indicator management program 25 includes a tool bar 70 that includes a message event 71, a desk band 72, and a handler 73.

The tool bar 70, which is installed at a desktop of the client server 20 and is operated by a user, performs a role of assisting the function of generating the indicator 100 by the indicator generating module 120 and the function of establishing the advertisement by the indicator establishing module 130 and a role of ensuring the interlocking relationship with the system server 30. In detail, the tool bar 70 includes the message event 71, the desk band 72, and the handler 73.

The message event 71, which is a tool used by a user, is a means that generates commands and signals according to the signal for generating indicator 100 to the indicator generating module 120 and transmits and calls the generated commands and signals. In detail, the message event 71 performs a role of a vehicle that allows the user of the client server 20 to generate signals so as to smoothly perform a block establishing function, a coordinate measuring function, and an input function and to transmit the generated signals to the system server 30.

The desk band 72, which is an object positioned on the desktop and the task bar, is formed to be interlocked with the system server 30 in real time according to the client server 20 that maintains a turn-on state so as to perform each configuration module while the client server 20 is operated. Also, the desk band 72 performs a role of transmitting the web site access information of the user to an access information analyzing module to be described below while interlocking to the web site 50 operated in the system server 30 in real time.

The handler 73 is a tool usable when changing the advertisement contents of each indicator or establishing the exposed position by the indicator establishing module 130 to be described below.

Referring to FIG. 4, the client server 20 operated and managed by the user includes the previously installed indicator management program 25, the tool bar 70, and the indicator establishing module 130. The system server 30, which comprehensively operates and manages the indicator 100 and forms the interlocking relationship with the web site 50, includes the layer forming module 110, the indicator generating module 120, the calculation module 140, the web page moving grasp module 150, the access information grasp module 160, and the interlocking module 170. The DB server 60 includes the indicator database 105, the user database 106, the advertisement database 207, the calculation database 108, the interlocking database 109, etc.

However, it is not important that each component in the system 10 according to the present invention exists in a predetermined server, but it is important that each component in the client server 20 and the system server 30 is interlocked and has a special function or not. Therefore, the detailed functions and operations of each component will be described below with reference to FIGS. 3 and 4.

The layer forming module 110 according to the present invention performs a function of generating the layer 101 on which the indicator will be positioned, wherein the layer 101 can be understood as a concept similar to a kind of transparent films that are transparently stacked on the specific web page.

In other words, in order to conveniently pursue implementation and generality, a method of physically inserting the indicator 100 within the specific space of the web page 40 is not used, but when the indicator 100 is displayed on the monitor, a method of using a medium that can display the corresponding information so as to display the information stacked on the corresponding web page 40 is used. The medium having characteristics similar to the transparent film is the layer 101.

The layer 101 described in the present invention is not a concept similar to the transparent film merely covering the web page 40, but can be identified only in a transparent state. Therefore, the form of the layer may have a general web page structure.

For example, the layer 101 is formed in a structure that can perform the entire link, display document/moving picture, input of contents, etc. The indicator 100 can be inserted and activated into the layer 101 only after the layer 101 should has the web page structure.

In other words, the layer 101 of the present invention has a transparent or translucent state such that all the web pages 40 positioned beneath the layer 101 can be identified, but appropriately understood that a separate web page (layer) is stacked on the specific web page 40.

The layer 101 shares one's feature with the indicator 100. In other words, when the indicator 100 is activated, the layer 101 is also activated, and in contrast, when the indicator 100 disappears, the layer 101 also disappears. It goes without saying consideration of the basic characteristics of the layer 100 correspond to the base form for displaying the indicator 100.

Specifically, the layer forming module 110 forms a layer 101 having a specific size depending on a size standard occupied by the specific web page 40 or the monitor size standard and when the web page 40 is opened on the computer monitor, performs a function to activate the layer on the surface of the web page 40 immediately after the window of the web page 40 is generated.

In other words, the layer forming module 110 includes an activation unit 111, a layer size auto-establishing unit 112 that includes the layer 101 corresponding to the change in the size of the web page 40, a layer transparency controlling unit 113 that controls transparency of the layer 101, a coordinate partitioning unit 114, an indicator position controlling unit 115 that controls a formation distance of positions of each indicator when the plurality of indicators 100 exist on the single layer 111, and a multi-layer forming unit 116 that forms the plurality of layers, that is, the multi-layers.

The activation unit 111 receives the web page activation signals from the layer forming module when the web page 40 is activated on the monitor to perform a function of forming the layer 101 on the surface of the web page 40.

The layer size auto-establishing unit 112 receives the size value of the web page 40 to allow the layer 101 activated by the activation unit 111 to correspond to the rate size of the web page 40, such that it performs a function of automatically controlling the layer size to have the same layer size as the received size value.

The layer transparency controlling unit 113 performs a role of controlling the transparent state of the layer 101. Generally, the layer 101 becomes a transparent state, such that the user can identify only the web page 40 without the user feeling another layer 101 exists on the surface of the web page 40. In some cases, the layer 101 is colored or when intending to control brightness/chroma, the color tone, translucent state, or transparency can be controlled by the layer transparency controlling unit 113.

The coordinate partitioning unit 114 partitions the layer form into x and y axes to grasp positional information on each point. When the indicator 100 is attached to the position of the specific layer 101, the coordinate partitioning unit 114 can grasp and control the indicator attachment position by referencing the layer coordinate values.

The indicator position controlling unit 115 sets a minimum approaching distance when the plurality of indicators 100 are formed in one layer 101, such that it serves not to form the neighboring indicators within this distance. In other words, in the present invention, the plurality of indicators 100 can be activated in one layer 101. In this case, the indicator position controlling unit 115 performs a function of establishing rules of the positions of the indicators 100 formed on one layer 101.

In order to prevent a user's confusion due to the formation of too many indicators 100 in one layer 101, the indicator position controlling unit 115 prevents other indicators 100 from being formed within a predetermined distance in the vicinity of the indicator 100.

The multi-layer forming unit 116 has a function of forming the layer 101 including the indicator 100 in plural. In other words, it has a function of forming another layer 101 including a separate indicator 100 on the upper part of the layer 101 formed on the web page 40. This can be used when the indicators 100 to be displayed are considerably many such that it is difficult to display all the indicators 100 on one plane, that is, one layer 101 or when another indicator is stacked on the specific indicator. Thereby, the multi-layer forming unit stacks a separate layer on the upper part of the corresponding layer 101 and establishes the color of the indicator 100 to be translucent, such that only one indicator 100 does not exist on the surface of the specific web page 40, but the plurality of indicators 100 are stacked.

When the plurality of indicators 100 are stacked on the specific web page space through the plurality of layers 101, higher advertising cost is allotted to the uppermost indicator 100 and lower advertising cost is allotted to the indicator 100 beneath the uppermost indicator 100, such that the diversity of the advertisement selection can be secured and a message, such as “three indicators are stacked in this space. Do you see all the indicators?” is displayed in vicinity of the indicator 100 when the indicators 100 are stacked.

The layer 101 according to the present invention formed by the above-mentioned configuration can secure stability of the system as compared with one directly displaying the indicator 100 on the specific web page 40 and can form the indicator 100 using a small capacity of memory. The concept of the layer 101 may be one of features largely differentiated from Registered Patent No. 705474 as the indicator related contents issued to the present applicant.

The indicator generating module 120 is provided in the client server 20 and the system server 30, respectively to perform a core function of generating and storing the indicator 100. In detail, the indicator generating module 120 includes a block establishing unit 121, a coordinate establishing unit 122, an input unit 123, a storing unit 124, a layer output unit 125, and a shape changing unit 126.

First, the block establishing unit 121 designates and selects the positions wanting to generate the indicator 100 in the corresponding web page 40 to expect a portion of the web page 40 in which the approximate shape of the indicator 100 will be recorded, that is, a width. The shape of the indicator 100 may have various shapes, such as a quadrangle similar to a general scratch paper, a trapezoid, a circle, and an oval, etc.

The coordinate establishing unit 122 reads the coordinate values of the portion of the web page 40 corresponding to the portion established in the block establishing unit 121 and makes the read coordinate value into numerical value and records each content according to the coordinate information since all the web pages 40 have generally pre-determined coordinate values regardless of the shape output from the monitor, such that the coordinate information already existing on the web page 40 is calculated according to the position established in the block establishing unit 121 in order to get ready to store the indicator 100 at the position of the specific web page 40 by the coordinate values.

In other words, although the web page 40 is differently displayed according to the user's screen size by a function of displaying the indicator 100 according to the coordinate establishing unit 122, it is possible to accurately display the indicator 100 on the corresponding portion by grasping a correct position.

The input unit 123, which provides a role of recording the contents of the indicator 100, that is, the advertisement contents to be described below, can write the detailed contents with the help of the message event 61 of the indicator establishing module 130 and the tool bar 60.

The storing unit 124 performs a role of a step that stores the coordinate information obtained in the coordinate establishing unit 122, URL of the corresponding web page 40, and the contents input to the input unit 123 to build the indicator database 105. The information stored in the storing unit 124 is temporally stored through the memory included in the client server 20 and then transmits the stored information to the system server 30, otherwise can directly transmit the stored information to the system server 30. The information stored in the system server 30 may be transmitted to the client sever 20 when the client server 20 calls the indicator 100 later and the indicator database 105 implemented by the systematic aggregation of information can be transmitted.

Also, briefly describing the security of the storing unit 124, the documents implement on the web page 40 and other contents are generally prepared as HTML document. If a java script language is used when several HTML documents in addition to the indicator 100 are prepared, since the source may be exposed to the outside, making it easily exposed to security breach, the storing unit 124 is prepared as a DLL file, which is an executable file, by easily copying the function of the indicator 100 by other companies, making it possible to previously prevent the leakage of the source for the indicator 100 and to increase the processing speed.

Further, when storing the indicator in the storing unit 124, the outline or internal basic color of the indicator 100 can be variously represented according to a user's taste. If the indicator 100 is configured to cover the contents targeted by the web page 40, since the contents are covered due to the indicator 100, it is possible to translucently configure the indicator 100.

Further, when the indicator 100 is stored in the storing unit 124, the storing format can be determined. Specifically, the storing format can be formed of a mobile format, an image format, a moving picture format, a HTML format, etc. This is to activate the indicator 100 in the web page or the mobile interface supporting the specific format without any difficulty. Further, in order to be interlocked with the heterogeneity database using XML, the heterogeneity database can be converted and stored in the database having various kinds devices using the known conversion tool or the conversion module

The layer output unit 125, which has a function of implementing the indicator generated through the process on the layer, has a role of inserting/activating the indicator at the specific coordinate position on the layer corresponding to the coordinate position of the web page.

In other words, the information stored in the storing unit 124 is transmitted to the client server when calling the indicator 100 (when activating the web page associated with the mainly specific indicator) to perform a function of outputting the indicator 10 on the layer 101 through the monitor interlocked with the client server 20.

The shape changing unit 126, which is used when adjusting the position of the indicator 100, provides a function of moving the indicator 100 and transmits the changed coordinate values to the coordinate establishing unit 122, such that it re-establishes the position to the new coordinate values, making it possible to increase or reduce the size.

It is possible to provide a method capable of attaching the indicator 100 on the layer that is generated on the web page 40 through the above-mentioned indicator generation module 120.

The indicator establishing module 130 according to the present invention performs a role of ruling the detailed advertisement contents and advertisement conditions of the indicator 100 that basically performs the advertisement function. The indicator establishing module includes a contents establishing unit 131, a category establishing unit 132, a positional establishing unit 133, a keyword establishing unit 134, an URL establishing unit 135, an exposed time establishing unit 136, and a schedule establishing unit 137.

The indicator establishing module 130 can access and execute to the advertisement application icons attached to the indicator 100 or the separate web page operated in the system server 30, making it possible to provide convenient interface environments to allow a user to easily perform the identification and control.

The contents establishing unit 131, which establishes the advertisement contents, is interlocked with the advertisement database 107.

The advertisement database 107 according to the present invention, which supports all of the moving image having various format types, images, flashes, HTML formats, and MOBILE formats, means the advertisement content information aggregations in which various advertisement contents suitable for these detailed formats are recorded.

Therefore, the user can freely select his/her desired advertisement formats and contents in the advertisement database 107, otherwise can be custom-manufactured separately.

The category establishing unit 132 performs a function of establishing a classification system according to the advertisement contents of the indicator 100. For example, the category establishing unit 132 has a function of setting and classifying the indicator 100 recording the shoes advertisement contents into miscellaneous goods, shoes categories. Herein, the category can be embodied to have a detailed tree structure, such as a large classification, a middle classification, a small classification.

The positional establishing unit 133 is established to expose the indicator 100 at the specific portion of the specific web page 40. In this case, the positional establishing unit 133 has a role, which exposes a specific portion of the web page 40 wanting to be exposed regardless of the contents of the web page 40, for example, at a portion, such as a right lower end, a left upper end. To this end, the positional establishing unit 133 is interlocked with the coordinate partitioning unit 114 or the coordinate establishing unit 122 to receive the coordinate values at the specific portions required to be exposed on the web page 40 or the layer 101 and to expose the indicator 100 at the portion corresponding to the input coordinate values, specifically a portion of a layer 101.

Further, this positional establishing unit is interlocked with a specific fixing position as well as with a contents searching module (not shown) capable of grasping the contents of the web page, such that it can be expanded from specific words or contents to a function displaying the indicator.

The keyword establishing unit 134 is interlocked with a portal site or an inherent search engine of the present system to perform a role of activating the indicator 100 having contents associated with the keyword immediately after the web page 40 indicating the search results is exposed when the user searches the keywords including the specific words or associated with the specific words.

Preferably, the keyword establishing unit 134 is configured to extract the advertisement information associated with the keywords from the indicator database 105 when the user inputs the keywords through the search engine separately provided at the system server 30 and to activate the indicator 100.

For example, in the search engine, when the user inputs the keyword referred to “shoes”, the web page 40 indicating the search information associated with shoes is activated and at the same time, the indicator 100 having the advertisement contents associated with shoes is also activated.

When the URL establishing unit 135 directly inputs the URL of the specific web page 40 through the address window, the web page 100 having the corresponding URL is activated. At this time, the indicator 100 performs a role of activating the indicator 100 immediately after the web page 40 is activated.

For example, when the user inputs www.naver.com, the naver main web page 40 is activated and at the same time, the indicator 100 together with the generation of the layer 101 is exposed. In other words, the URL establishing unit 135, which initially accesses the specific web page 40 and at the same time, provides a function of activating the indicator 100, can allow the exposure in the web page having a plurality of URLs for one indicator 100 as a method capable of unconditionally activating the indicator 100 only when the URL referred to A, B, C, and D is input.

The exposing time establishing unit 136 performs a function by controlling the time (or time where the layer is activated) when the indicator 100 is exposed in the layer 101. This provides a role of activating and then dissappearing the indicator 100 in the layer 101 by a predetermined time because this inconveniences the user if the indicator 100 is fixedly activated whenever the user accesses to the web page 40.

This actively interconnects the user due to the activation and disappearance of the layer 101. For example, when exposure is established in 10 seconds, the layer 101 on the specific web page 40 and the indicator implemented thereon are activated during 10 seconds.

The schedule establishing unit 137 provides a function of activating the indicator 100 in the corresponding web page 40 only during the specific period. In other words, the schedule establishing unit 137, which performs a role of establishing the advertisement period, can activate the indicator 100 in the specific web page 40 only during June 1 to June 10.

A bidding unit 138 is interlocked with the calculation module to adjust the bid ranking or the advertisement determination or to provide a function of allowing an advertiser to establish the differentiated indicator advertisement ranking per cost so as to determine the indicator differentiation generation position (for example, a method of permitting an advertiser paying high advertisement costs to secure a central position or an upper position of a first layer) when the plurality of indicators are generated in the specific URL/keyword, the single/multi layer, etc. This provides a similar function to the advertisement ranking establishing program that is generally current performed.

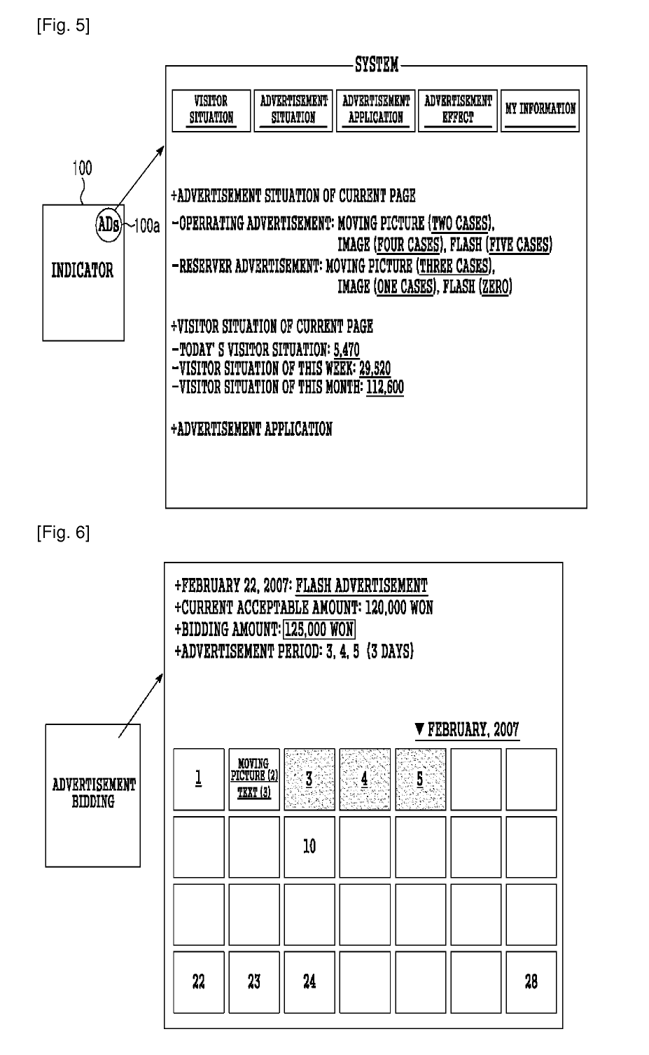

FIG. 5 is an exemplification view showing a process of applying the customized advertisement that uses the indicator in the advertisement establishing page through the function of the indicator establishing module according to the present invention and FIG. 6 is a view exemplifying a process of bidding the advertisement according to the present invention.

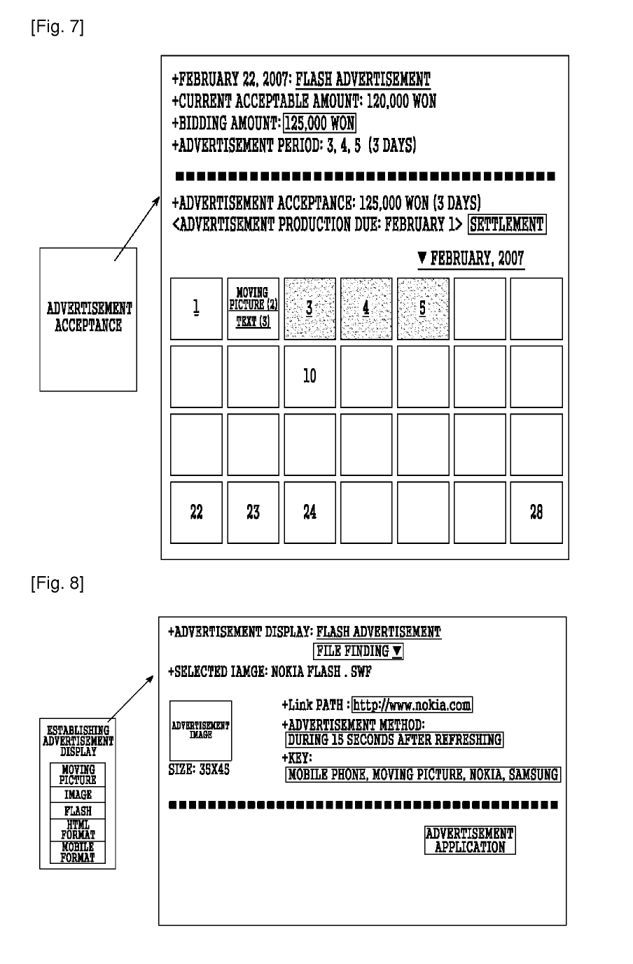

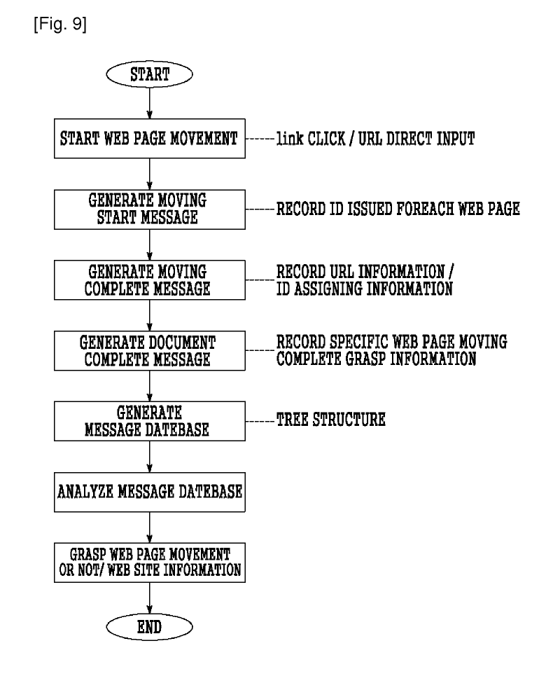

FIG. 7 is a view exemplifying a process of accepting the advertisement and FIG. 8 is an exemplification view showing a process of approving the advertisement according to the present invention.

As can be appreciated from FIG. 5, the indicator 100 has the advertisement establishing icon 100a. Accordingly, the user presses the advertisement establishing icon to indicate the advertisement establishing page capable of performing the advertisement application, which is interlocked with the indicator establishing module 130.

The advertisement establishing page is operated under the management of the indicator establishing module 130. In other words, the advertisement establishing page performs a role of the user interface of the indicator establishing module 130.

As can be appreciated from FIGS. 5 to 8, all the processes to allow the user to perform the customized advertisement are clearly arranged in the advertisement establishing page. Through this, the process of the advertisement establishment can be solved.

When the user visits the web page wanting the customized advertisement, calls the indicator on the web page, and presses the advertisement establishing icon 100a, he/she accesses the advertisement establishing page. Also, there are a visitor situation function that provides information on various visitors for each period on the web page wanting the advertisement, an advertisement situation function that provides in—formation on the operating customized advertisement or the reserved situation, and an advertisement effect function that indicates results or effects on the executed customized advertisement, and an advertisement application function that applies a substantial advertisement after subjecting to the processes. It is formed of the general user information, my information (my page) that can be modified, changed, and deleted, etc. Lastly, the advertisement establishment is achieved by being interlocked with the indicator establishing module 130.

The calculation module 140 according to the present invention has a function of calculating the advertisement cost according to the interlocking with the bidding unit 138 or the policy defined when implementing the customized advertisement in the indicator 100 according to the user's preference. The calculation module is similar to the calculation method of the known advertisement system and differentiates the advertisement costs for each indicator advertisement method selected in the indicator establishing module 130 to perform the calculation. The calculation module 140 is operated in real time, such that the indicator displaying the advertisement can be performed immediately after the calculation.

Further, the calculation module 140 further includes a profit distributing unit 141. Since the indicator 100 according to the present invention is performed only by the user having the indicator management program, whether the indicator distributing program is distributed to how many users can determine the success and failure of the present invention. Therefore, if the distributor leaves his/her name and information in the indicator management program 25 when distributing the indicator management program 25 through the Internet, the profit distributing unit 141 provides a function of distributing the advertisement profits, which are generated through the indicator management program 25 distributed from the distributor, to the distributor at a pre-determined ratio.

To this end, when uploading the indicator management program 25 into the specific web site, the distributor can install the function capable of leaving the distributor's name and information in the indicator management program 25. Meanwhile, a number of distributors from the first distributor to a subsequent distributor, such as first distributor, a second distributor, can be established.

In other words, the profit distributing unit 141 extracts the information on the distributors and calculates a separate profit distribution for distributors when calculating the advertisement costs later through the profit distribution.

FIG. 9 is a view schematically exemplifying a function of the web page moving grasp module 150 according to the present invention.

The web page moving grasp module 150 performs a function for grasping the moving tendency or the access situation of the web page of the user having the indicator management program 25. In detail, the web page moving grasp module 150 includes a moving message generating unit 151 and a message database generating unit 152.

First, the moving message generating unit 151 includes a moving start message generating unit 151a, a moving complete message generating unit 151b, and a document complete massage generating unit 151c such that the user accesses the web page 40 to generate the message three times up to the time when the download of the document completes and performs a role of transmitting the generated message to the system server 30.

The moving start message, which is a message generated after accessing the web page, includes ID issued to identify each web page.

The moving complete message, which is a message generated instantly for recognizing the web page after the moving start message is generated, includes URL information of the corresponding web page and assignment information recording whether the corresponding web page 40 is a main page or a sub page thorough ID.

The document complete message, which is a message generated when the loading of all the web pages completes, includes information analyzing which movement of the web page 40 completes.

The message database generating unit 152 complies the foregoing three messages based on the system server 30 to generate the message database, such that it has a function of analyzing a structure of the web page visited by the user. In particular, the message database generating unit 152 performs a function of grasping an entire structure, such as a main page, a sub page, etc. as a tree structure through three messages.

FIG. 9 shows a procedure executed when a specific user visits the web page 40, for example, referred to as A.

When the user visits the web page A, he/she generally visits the corresponding web page 40 as well as other web pages adjacent to the web page 40 in the same web page. Accordingly, the message is generated in the order of loading complete of moving start-moving complete-document loading complete for each page to grasp the structure of the web page 40 and then to integrate the messages, thereby generating the message database for each web page 40. Thus, the web page 40 visited by the user can be easier grasped and the access information can be arranged clearly.

By the web page moving grasp module 150, the information grasped based on the system in the existing log information analysis is analyzed based on the user that is a target of the advertisement, making it possible to obtain more useful advertisement analysis information.

The access information grasp module 160 performs a role of analyzing the connection tendency of the user having the indicator management program 25 and transferring the information to efficiently use the advertisement to the advertiser through the analysis. The access information grasp module 160 clicks the indicator 100 associated with the specific web page 40, such that is can extract a general log in—formation such as the information connected to the advertisement web page and the detailed user access situation information through the message database obtained from the web page moving grasp module 150.

In other words, the access information grasp module 160 analyzes the message database, making it possible to obtain information, such as the web page accessed by many users, taste for each age, accessed web page tendency, etc. This information performs a role of transferring various access information, such as the number of clicks for the specific web pages, visitors, amount of advertisements, period of advertisements, etc., to the advertiser.

The interlocking module 170 according to the present invention performs a function of exchanging and using the indicator information with various information devices, such as mobile phone, PDA, MP3, PMP, TV, etc, that belong to the interlocking database 109 for sharing and processing various information with the client server 20 and various external servers.

In other words, the indicator 100 according to the present invention is not necessarily performed on only the web page, but can theoretically be activated in the mobile device. The interlocking module 170 performs a role of compatibly interlocking the wired and wireless information formed in the web page and the mobile device.

In addition, the system according to the present invention includes an evaluation means that allows a user to evaluate the advertisement contents of the indicator to give a benefit of the advertisement costs or the advertisement exposed time according to the evaluation contents, a production management means that produces the advertisement database and connects the produced advertisement database to the advertiser, an advertisement contents transaction means that can provide or transaction the advertisement database between the user.

As described above, the configuration and operation of the system for managing the customized advertisement that uses the indicator in the web page is described in the description and drawings, but is only described by way of example. The idea of the present invention is not limited to the description and drawings and it is apparent to those skilled in the art that various modifications and changes may be made without departing from the scope and spirit of the invention.

What is claimed is:

1-9. (canceled)

10. A system for managing a customized advertisement, comprising:
an indicator management program located on a client server;
a layer that is stacked on a surface of a specific web page at a size corresponding to a web page and is output from a monitor;
a layer forming module that activates the layer when the specific web page is activated and controls the size of the layer to the size of the specific web page;
at least one indicator that is included in the layer and is associated with coordinate values corresponding to specific contents or space positions to be exposed on the surface of the specific web page;
an indicator generating module that generates the indicator; and
an indicator establishing module that forms advertisement content in the indicator.

11. The system of claim 10, wherein the indicator establishing module determines an advertisement progress by use of a bidding unit performing a bid for an advertiser target; and the system further comprises a calculation module that calculates advertisement costs according to progress of the advertisement.

12. The system of claim 10, wherein the layer forming module further includes a layer transparency controlling unit that controls transparency, brightness, or chroma of the layer.

13. The system of claim 10, wherein the layer forming module further includes a multi-layer forming unit that forms a plurality of layers to be stacked on the specific web page.

14. The system of claim 10, wherein the indicator generating module further includes a storing unit that stores the indicator in any one of a mobile format, an image format, a moving picture format, and a HTML format.

15. The system of claim 10, wherein:
the indicator management program includes a search engine; and
the indicator establishing module further includes a keyword establishing unit, such that when a user searches specific keywords through the search engine, the keyword establishing unit activates the indicator having contents associated with the specific keywords immediately after a web page indicating the search result is exposed.

16. The system of claim 10, wherein the indicator establishing module further includes an exposed time controlling unit that controls time when the layer and the indicator are continued in the specific web page.

17. The system of claim 10, further including an access information grasp module that analyzes user access information of the specific web page on which the indicator is displayed.

18. The system of claim 17, further including at least one of:
a web page moving grasp module that grasps the user access information of the specific web page for a user having the indicator management program and transmits the grasped user access information to the access information grasp module, the web page moving grasp module including:
a moving start message generating unit that generates a moving start message after accessing the specific web page and includes an ID issued so as to identify each specific web page;
a moving complete message generating unit that, after the moving start message is generated, generates a moving complete message at an instant of recognizing the specific web page and includes URL information of the specific web page and assignment information recording whether the specific web page is a main page or a sub page through the ID;
a document complete message generating unit that generates a document complete message when the loading of all the specific web pages is completed and includes information analyzing the movement of the specific web pages; and
a message database generating unit that generates a message database by compiling the moving start, moving complete, and document complete messages; wherein the message database provides the user access information for each specific page and is transmitted to the access information grasp module.

19. The system of claim 10, further including an interlocking module that interlocks the indicator information with various information devices, such as mobile phones, PDAs, MP3, PMP, TV.

20. A computer-implemented method for managing customized advertisements, comprising:
stacking a layer on a surface of a specific web page at a size corresponding to a web page and is output from a monitor;
activating the layer when the specific web page is activated and controls the size of the layer to the size of the specific web page;
associating at least one indicator included in the layer with coordinate values corresponding to specific contents or space positions to be exposed on the surface of the specific web page;
generating the indicator; and
forming advertisement content in the indicator.

21. The method of claim 20, further comprising:
determining an advertisement progress by a bidding unit performing a bid for an advertiser target; and
calculating advertisement costs according to the progress of the advertisement.

22. The method of claim 20, wherein the layer has controllable transparency, brightness, or chroma.

23. The method of claim 20, wherein a plurality of layers are stacked on the specific web page.

24. The method of claim 20, wherein the at least one indicator is stored in any one of a mobile format, an image format, a moving picture format, and a HTML format.

25. The method of claim 20, further comprising:
a search engine; and
when a user searches specific keywords through the search engine, activating the indicator having contents associated with the specific keywords immediately after a web page indicating the search results is exposed.

26. The method of claim 20, wherein the indicator and the layer are exposed on the specific webpage for a pre-determined amount of time.

27. The method of claim 20, further comprising:
interlocking information associated with the indicator with various information devices, such as mobile phones, PDAs, MP3, PMP, TV.

28. The method of claim 20, further comprising:
analyzing user access information of the specific web page on which the indicator is displayed.

29. The method of claim 28, further including:
grasping user access information of the specific web page for a user and transmitting the grasped user access information to an access information grasp module, the grasping including:
after accessing the specific web page, generating a moving start message and an ID to identify each specific web page;
after the moving start message is generated and at an instant of recognizing the specific web page, generating a moving complete message and URL information of the specific webpage and assignment information recording whether the specific page is a main page or a sub page through the ID;
when the loading of all of the specific web pages is completed, generating a document complete message which includes information analyzing the movement of the specific web page; and
generating a message database by compiling the moving start, moving complete, and document complete messages; wherein the message database provides the user access information and is transmitted to the access information grasp module.

30. A computer readable storage medium having stored thereon a set of instructions that, when executed by a computer system, cause the computer system to perform a method including:
stacking a layer on a surface of a specific web page at a size corresponding to a web page and is output from a monitor;
activating the layer when the specific web page is activated and controls the size of the layer to the size of the specific web page;
associating at least one indicator included in the layer with coordinate values corresponding to specific contents or space positions to be exposed on the surface of the specific web page;
generating the indicator; and
forming advertisement content in the indicator.

31. The computer readable storage medium of claim 30, further comprising instructions for:
determining an advertisement progress by a bidding unit performing a bid for an advertiser target; and
calculating advertisement costs according to the progress of the advertisement.
